(19) United States
(12) Patent Application Publication
(10) Pub. No.: US 2024/0403824 A1
(43) Pub. Date: Dec. 5, 2024

(54) METHOD FOR DEPLOYING A ROBOTIC SYSTEM TO SCAN INVENTORY WITHIN A STORE

(71) Applicant: Simbe Robotics, Inc., South San Francisco, CA (US)

(72) Inventors: Jariullah Safi, South San Francisco, CA (US); Bradley Bogolea, South San Francisco, CA (US); Durgesh Tiwari, South San Francisco, CA (US); Lorin Vandegrift, South San Francisco, CA (US); Cem Ersoz, South San Francisco, CA (US)

(21) Appl. No.: 18/803,355

(22) Filed: Aug. 13, 2024

Related U.S. Application Data
(63) Continuation-in-part of application No. 17/576,701, filed on Jan. 14, 2022.
(60) Provisional application No. 63/138,331, filed on Jan. 15, 2021.

(51) Int. Cl. G06Q 10/087; G06Q 10/047; G06Q 10/0631

(52) U.S. Cl. CPC G06Q 10/087; G06Q 10/047; G06Q 10/06316

(57) ABSTRACT

One variation of a method for deploying a robotic system to scan inventory within a store includes: retrieving generic recommended baseline scan frequencies assigned to a set of product types stocked in the store; annotating a map of the store according to generic recommended baseline scan frequencies and locations of the set of product types in the store; overwriting baseline scan frequencies assigned to locations in the store based on inputs from the user; accessing elapsed times since capture of last images of slots in the store, assigned to these product types, by the robotic system; calculating urgency scores for imaging these slots proportional to differences between elapsed times and scan frequencies; and calculating a scan route traversable by the robotic system to preferentially locate, within the field of view of the robotic system, locations in the store associated with higher urgency scores over locations associated with lower urgency scores.

### CROSS-REFERENCE TO RELATED APPLICATIONS

This application is a continuation-in-part application of U.S. patent application Ser. No. 17/576,701 filed on 14 Jan. 2022, which claims priority to U.S. Provisional Patent Application No. 63/138,331 filed on 15 Jan. 2021, each of which is incorporated in its entirety by this reference.

### TECHNICAL FIELD

This invention relates generally to the field of stock keeping and more specifically to a new and useful method for deploying a robotic system to scan inventory within a store in the field of stock keeping.

### BRIEF DESCRIPTION OF THE FIGURES

FIG. 1 is a flowchart representation of a method.

FIG. 2 is a flowchart representation of one variation of the method;

FIG. 3 is a flowchart representation of one variation of the method;

FIG. 4 is a schematic representation of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

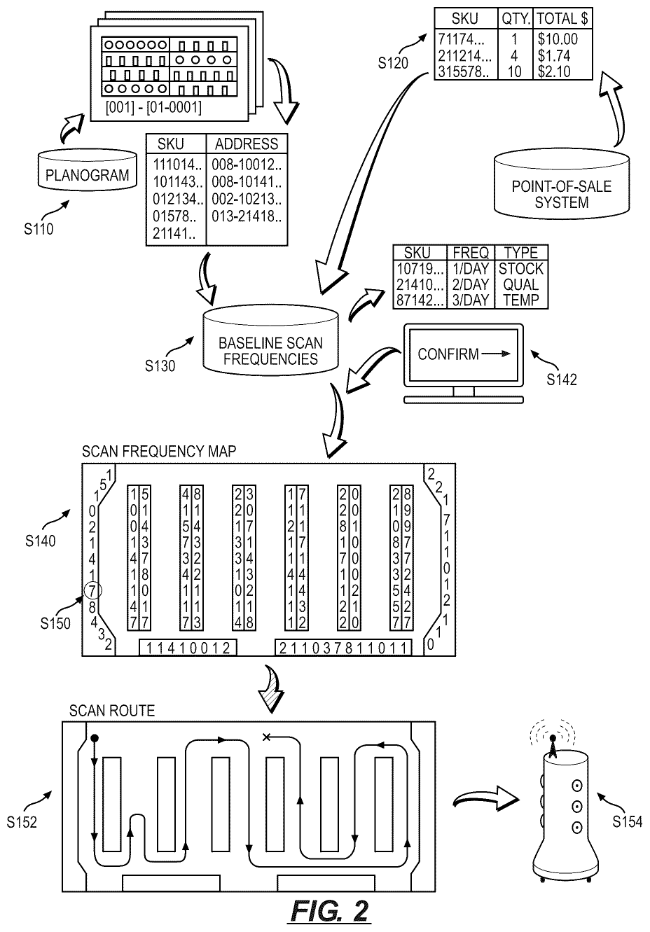

As shown in FIG. 2, a method S100 for deploying a robotic system to scan inventory within a store includes: accessing a planogram of the store in Block S110; and extracting a set of product type identifiers from the planogram in Block S120. The method S100 also includes, for each product type identifier in the set of product type identifiers: retrieving a generic recommended baseline scan frequency assigned to the specific product type identifier in Block S130; retrieving a generic recommended scan type assigned to the product type identifier in Block S132; aggregating a set of locations in the store assigned to the product type identifier in Block S134; and linking the generic recommended baseline scan frequency and the generic recommended scan type to the set of locations in Block S136. The method S100 further includes: annotating a map of the store according to generic recommended baseline scan frequencies, generic recommended scan types, and locations linked to the set of product type identifiers in Block S140; serving the map to a user in Block S142; and rewriting a first baseline scan frequency to a first location in the store, linked to a first product type identifier, based on a first selection from the user in Block S144.

The method S100 also includes, at a first time prior to a scan cycle executed by a robotic system deployed in the store: for each product type identifier in the set of product type identifiers, calculating a first score of a location in the store linked to the product type identifier proportional to a duration of time remaining to scan the location before failing to fulfill a scan frequency assigned to the product type identifier in Block S150; calculating a first continuous scan route that, when traversed by the robotic system, maximizes a sum of first scores of locations that fall within the field of view of the robotic system per consecutive unit distance along the first continuous scan traversed by the robotic system in Block S152; and uploading the first continuous scan route to the robotic system in Block S154.

The method S100 further includes, at a second time during the scan cycle executed by the robotic system: for each product type identifier in the set of product type identifiers, calculating a second score of a location in the store linked to the product type identifier proportional to a duration of time remaining to scan the location before failing to fulfill a scan frequency assigned to the product type identifier in Block S160; calculating a second continuous scan route, from a current location of the robotic system to a dock location, that, when traversed by the robotic system, maximizes a sum of second scores of locations that fall within the field of view of the robotic system per consecutive unit distance along the second continuous scan traversed by the robotic system in Block S162; and replacing the first continuous scan route with the second continuous scan route at the robotic system in Block S164.

### 1.1 Recalculated Scan Route

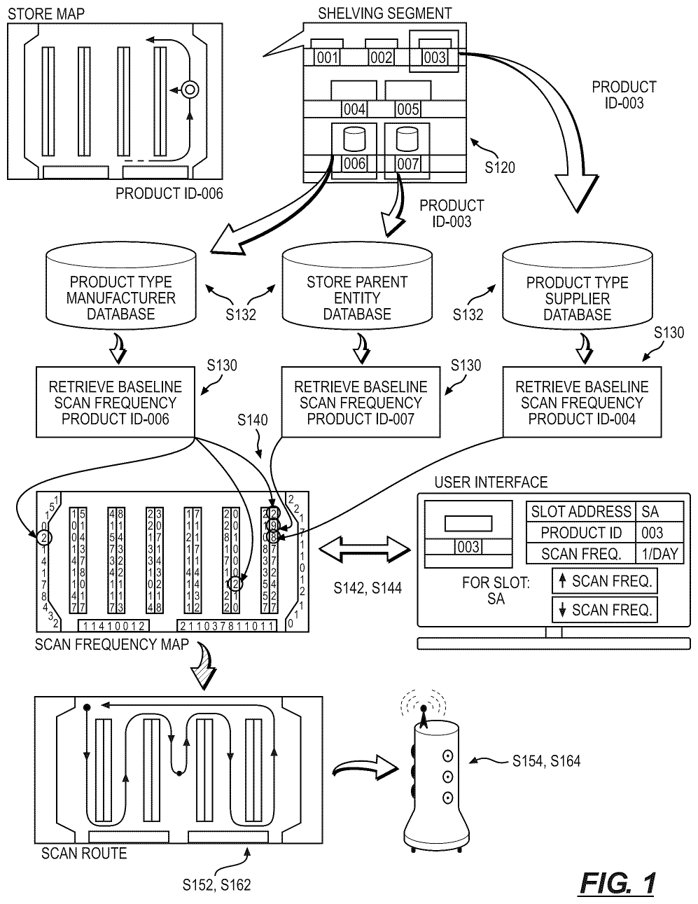

One variation of the method S100, as shown in FIG. 1, includes, for each product type in a set of product types stocked in the store: retrieving a scan frequency assigned to the product type in Block S130; accessing a set of locations in the store assigned to the product type in Block S134, and linking each baseline scan frequency in the set of baseline scan frequencies to a location in the set of locations in Block 136. This variation of the method S100 also includes, at a first time, for a scan cycle executed by a robotic system deployed in the store: for each product type in the set of product types: accessing a first elapsed time since a last scan of a location in the store assigned to the product type; calculating a first time remaining based on a first difference between the first elapsed time and a scan frequency assigned to the product type; and calculating a first urgency score of the location in the store based on the first time remaining in Block S150. This variation of the method S100 further includes: calculating a first scan route that, when traversed by the robotic system, preferentially locates, within the field of view of the robotic system, locations in the store associated with higher first urgency scores over locations in the store associated with lower first urgency scores in Block S152; and, at the robotic system, loading the first scan route for execution during the scan cycle in Block S154.

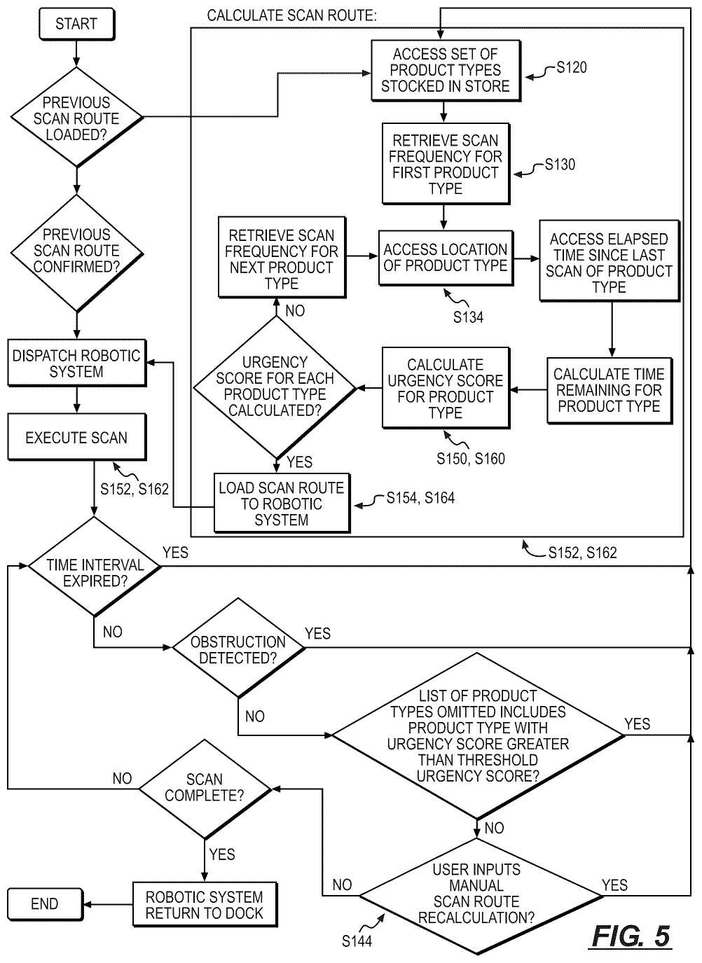

This variation of the method S100, shown in FIG. 5, similarly includes, at a second time during execution of the scan cycle by the robotic system, for each product type in the set of product types: accessing a second elapsed time since a last scan of a location in the store assigned to the product type; calculating a second time remaining based on a second difference between the second elapsed time and a scan frequency assigned to the product type; and calculating a second urgency score of the location in the store based on the second time remaining in Block S160. This variation of the method S100 further includes: calculating a second scan route, from a current location of the robotic system at the second time to a dock location in the store, that, when traversed by the robotic system, preferentially locates, within the field of view of the robotic system, locations in the store associated with higher second urgency scores over locations in the store associated with lower second urgency scores in Block S162; and, at the robotic system, loading the second scan route, in replacement of the first scan route, for execution during the scan cycle in Block S164.

### 1.2 Scan Route Imaging

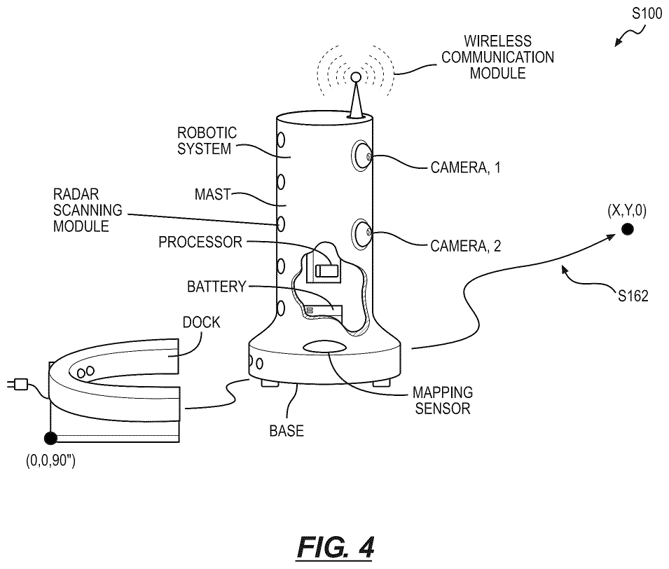

In another variation of the method S100, as shown in FIG. 1, the computer system can, at a first time and for a first product type in a set of product types: retrieve a scan frequency assigned to the first product type in Block S130; and access a first elapsed time since a last image of a slot—assigned to the first product type in the store—was captured by the robotic system in Block S150. The computer system can then calculate an urgency score for imaging the slot proportional to a difference between the first elapsed time and the scan frequency in Block S150. The computer system can then calculate a first scan route that preferentially locates—within the field of view of the robotic system—locations in the store associated with higher first urgency scores over locations in the store associated with lower first urgency scores in Block S152. The robotic system, as shown in FIG. 4, can then: autonomously navigate within the store according to the first scan route in Block S162; and capture images of a first subset of slots in the store in Block S164. The computer system can then, at a second time during execution of the scan cycle executed by the robotic system, for the first product type: retrieve a scan frequency assigned to the first product type in Block S130; access a second elapsed time since a last image of a slot in the store—assigned to the first product type—was captured by the robotic system in Block S160; and recalculate an urgency score for imaging the slot proportional to a difference between the second elapsed time and the scan frequency in Block S160. The computer system can then calculate a second scan route, from a current location of the robotic system to a dock location in the store, that preferentially locates—within the field of view of the robotic system—locations in the store associated with higher first urgency scores over locations in the store associated with lower first urgency scores in Block S162. The robotic system can then: load the second scan route, in replacement of the first scan route; autonomously navigate within the store according to the second scan route; and capture images of a first subset of slots in the store in Block S164. The computer system can repeat this process for the other product types in the set of product types.

### 1.3 Scan Frequency Map+Overwrites

In another variation of the method S100 shown in FIG. 5, the computer system can, for a first product type in a set of product types stocked in the store: retrieve a generic recommended baseline scan frequency assigned to the product type in Block S132; and access a set of locations in the store assigned to the product type in Block S134. The computer system can then: annotate a map of the store according to the generic recommended baseline scan frequency and a first location in the store assigned to the first product type in Block S140; and present the map to a user affiliated with the store in Block S142. The computer system can then—based on a first input from the user—overwrite a first baseline scan frequency of the first product type in Block S144. The computer system can then, at a first time, for the first product type, and for a scan cycle executed by a robotic system deployed in the store: retrieve a scan frequency assigned to the product type in Block S130; access a first elapsed time since a last image of a slot in the store—assigned to the product type—was captured by the robotic system in Block S150; and calculate an urgency score for imaging the slot proportional to a difference between the first elapsed time and the scan frequency in Block S150. The computer system can then calculate a first scan route that preferentially locates, within the field of view of the robotic system, locations in the store associated with higher first urgency scores over locations in the store associated with lower first urgency scores in Block S152. The robotic system can then: autonomously navigate within the store according to the first scan route in Block S154; and capture images of a first subset of slots in the store. The computer system can repeat this process for the other product types in the set of product types.

Furthermore, in this variation, the computer system can—at a second time during execution of the scan cycle by the robotic system—for a first product type: access a second elapsed time since a last scan of a location in the store assigned to the product type in Block S160; calculate a second time remaining based on a second difference between the second elapsed time and a scan frequency assigned to the product type in Block S160; and calculate a second urgency score of the location in the store based on the second time remaining in Block S160. The computer system can then calculate a second scan route, from a current location of the robotic system at the second time to a dock location in the store, that, when traversed by the robotic system, preferentially locates, within the field of view of the robotic system, locations in the store associated with higher second urgency scores over locations in the store associated with lower second urgency scores in Block S162. The computer system can then load the second scan route at the robotic system—in replacement of the first scan route—for execution during the scan cycle in Block S164. The computer system can repeat this process for all other product types in the set of product types.

### 2. Applications

Generally, the method S100 can be executed by a computer system (e.g., a local or remote computer system, a computer network, a server) in cooperation with a robotic system deployed in a store (e.g., a grocery store, a dry goods store, a sporting goods store) to automatically assign baseline scan frequencies (e.g., once per hour, once per day, or once per week) to slots throughout the store and to automatically assign baseline scan types (e.g., stock state check, temperature check, produce quality check) to these slots based on product types assigned to these slots, such as by a planogram of the store.

The computer system can further execute Blocks of the method S100 to generate a visualization of baseline scan frequencies and scan types assigned to slots throughout the store and interface with a user (e.g., a store manager, a robotic system operator)—via this visualization to adjust (or “customize”) scan frequencies and scan types assigned to these slots, thereby enabling the user to quickly set scanning parameters for slots containing high-interest, high-sale-rate, and/or high-risk products while also ensuring that all other slots in the store are assigned acceptable scanning parameters, thus enabling the user to complete setup for the robotic system and deploy the robotic system to scan the store within a short setup period. The computer system can similarly interface with the user to rapidly adjust and update these scanning parameters for individual slots, shelves, shelving segments, shelving structures, and/or sections of the store over time.

The computer system can access a predefined set of baseline scan frequencies, established by: the store staff, such as the store manager; an entity affiliated with the store, such as a parent entity of the store; or an entity affiliated with a product type, such as a manufacturer or supplier of the product type.

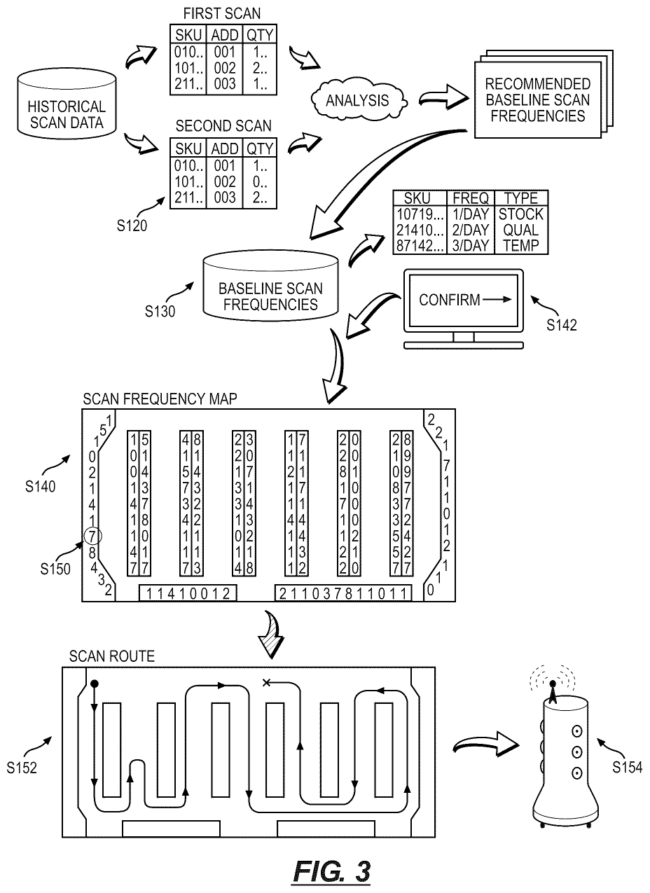

The computer system can also, as shown in FIG. 3, derive a set of baseline scan frequencies based on data retrieved from a system affiliated with a store, such as a point-of-sale system or inventory management system. For example, the computer system can access the point-of-sale system to retrieve a transaction record of a first product type and extract a sell-through rate of the first product type. The computer system can then calculate a scan frequency based on the sell-through rate of the first product type. The computer system can similarly calculate a scan frequency from other data retrieved from systems affiliated with the store. The computer system can repeat this process for other product types stocked in the store.

The computer system can also derive a set of baseline scan frequencies based on data collected in the store by the robotic system, such as images captured by the robotic system (and analyzed by the computer system). For example, the computer system can: access a set of previous scans to retrieve a first stock condition of a first product type corresponding to a first scan completed at a first time, and a second stock condition of the first product type corresponding to a second scan completed at a second time; identify a difference between the first stock condition and the second stock condition; identify a time difference between the first time and the second time; and calculate a rate of change of the first product type based on the difference between the first stock condition and the second stock condition and the difference between the first time and the second time. The computer system can then calculate a scan frequency for the first product type based on the rate of change of the first product type. The computer system can similarly calculate a scan frequency from other data derived from images captured by the robotic system. The computer system can repeat this process for all other product types stocked in the store.

The computer system (and/or the robotic system) can then implement Blocks of the method S100: to score (e.g., prioritize) individual slots throughout the store based on the last times these slots were scanned and their assigned scanning frequencies (which represent maximum time durations between consecutive scans of these slots); to calculate a scan route executable by the robotic system to autonomously navigate throughout and scan slots within the store based on the scores calculated for these slots; and to deploy the robotic system to execute this route during a scan cycle. The computer system (and/or the robotic system) can also update these scores and recalculate this route in real-time during a scan cycle—such as in light of both revised slot scores and temporary obstacles blocking the robotic system's path—in order to maintain scanning efficiency and effectiveness by the robotic system, including enabling the robotic system to fulfill scanning frequencies of a high (e.g., maximum) quantity of slots in the store despite store traffic, spills, and other variable conditions in the store.

For example, if the computer system assigns a single scan frequency to every product type in the store (e.g., once per day), then the robotic system may necessarily traverse every aisle in the store, image every slot in the store, wait for removal of all obstacles, therefore executing long-duration scan cycles, and thus requiring high battery capacity. Conversely, the computer system can execute the method S100 to assign a range of scan frequencies to various product types—and therefore to different slots or locations throughout the store stocked with these product types. Accordingly, during a scan cycle, the robotic system can: identify a first subset of locations in the store containing a product type assigned a scan frequency that can only be fulfilled by imaging during the current scan; identify a second subset of locations in the store containing a product types assigned a scan frequency that can only be fulfilled by imaging during a future scheduled scan cycle; and preferentially navigate to and image the first subset of locations over the second subset of locations.

Therefore, the computer system and/or the robotic system can execute Blocks of the method S100 to implement a flexible framework for scheduling, deploying, and monitoring a robotic system that autonomously scans slots within a store for product presence, temperature, and/or quality statuses of these slots.

The method S100 is described herein as executed by a computer system (e.g., a remote server, a computer network). However, Blocks of the method S100 can be executed by one or more robotic systems deployed in a retail space (or store, warehouse, etc.), by a local computer system (e.g., a local server), or by any other computer system. Furthermore, Blocks of the method S100 are described below as executed by the computer system to identify products stocked on open shelves on shelving structures within a store. However, the computer system can implement similar methods and techniques to identify products stocked in cubbies, in a refrigeration unit, on a wall rack, in a freestanding floor rack, on a table, in a hot-food display, or on or in any other product organizer or display in a retail space.

### 3. Hierarchy and Terms

A “product facing” is referred to herein as a side of a product (e.g., of a particular SKU or other product identifier) designated for a slot. A “planogram” is referred to herein as a plan or layout for display of multiple product facings across many shelving structures, inventory structures, and other inventory structures within a store (e.g., across an entire store). In particular, the planogram can specify target product identification, target product placement, target product quantity, target product quality (e.g., ripeness, time to peak ripeness, maximum bruising), and product orientation data for product facings and groups of loose product units for fully-stocked shelving structures, inventory structures, and other inventory structures within the store. For example, the planogram can define a graphical representation of product units assigned to slots in one or more inventory structures within the store. Alternatively, the planogram can record textual product placement for one or more inventory structures in the store in the form of a spreadsheet, slot index, or other database (hereinafter a “product placement database”).

A “slot” is referred to herein as a section (or a “bin”) of a customer-facing shelf on an “inventory structure” designated for storing and displaying product units of the product type (i.e., of the same SKU or CPU). An inventory structure can include an open, closed, humidity-controller, temperature-controlled, and/or other type of inventory structure containing one or more slots on one or more shelves. A “top shelf” is referred to herein as a shelf designated for local product inventory at an inventory structure, such a located above and/or offset inwardly from customer-facing shelves below.

A “store” is referred to herein as a (static or mobile) facility containing one or more inventory structures.

A “product” is referred to herein as a type of loose or packaged good associated with a particular product identifier (e.g., a SKU) and representing a particular class, type, and varietal. A “unit” or “product unit” is referred to herein as an instance of a product—such as one bottle of detergent, one box of cereal, or package of bottle water—associated with one SKU value.

Furthermore, a “realogram” is referred to herein as a representation of the actual products, actual product placement, actual product quantity, and actual product orientation of products and product units throughout the store during a scan cycle, such as derived by the computer system according to Blocks of the method S100 based on images and/or other data recorded by the robotic system while autonomously executing scan cycles in the store.

A “scan frequency” is described herein as a quantity of scans of a slot by the robotic system per unit time and thus represents a maximum time duration between consecutive scans of the slot by the robotic system.

A “scan type” is described herein as a sensor modality with which the robotic system scans a slot and the type of characteristic of the slot derived from such scan data, such as including: an image-based product presence scan type, such as described in U.S. patent application Ser. No. 15/600,527; an RFID-based product presence scan type, such as described in U.S. patent application Ser. No. 15/947,757; a temperature scan type, such as described in U.S. patent application Ser. No. 16/245,135; and a produce quality scan type, such as described in U.S. patent application Ser. No. 16/594,364, each of which is incorporated in its entirety by this reference.

### 3.1 Scan Route Terms

Generally, the method S100 is described herein as executed by a robotic system and a computer system to calculate a scan route that “preferentially locates”-within the field of view of the robotic system—locations in the store associated with higher urgency scores over locations in the store associated with lower urgency scores. In particular, the phrase “preferentially locate” is described herein as prioritizing or favoring locations in the store associated with urgency scores exceeding a threshold urgency score over locations associated with urgency scores falling below the threshold urgency score.

Furthermore, a “score” (or “urgency score”) is referred to herein as a priority for scanning or imaging a slot by the robotic system. The computer system can calculate an “urgency score” inversely proportional to a duration between a last time of a last scan of the slot and a next scheduled time for a scan of the slot, according to the scan frequency for this slot. Alternatively, the computer system can: calculate a duration between a last time of a last scan of the slot and a current time; detect a difference between the duration and a maximum duration between consecutive scans (e.g., a scan frequency); and calculate an “urgency score” inversely proportional to the difference between the duration and the maximum duration.

For example, the computer system can: retrieve a last time, such as 10 AM, associated with a scan of a slot by the robotic system; read a current time, such as 10:40 AM; retrieve a scan frequency and/or maximum time between consecutive scans assigned to this slot, such as once-per-hour; calculate a duration between the last time and the current time, such as 40 minutes; detect a difference between the duration and the maximum duration, such as 20 minutes; and calculate an urgency score inversely proportional to the difference, such as “95/100”.

Additionally, the computer system can dynamically define a threshold urgency score for the store as a function of time of day, day of week, day of month, and/or store occupancy (e.g., a quantity of customers in the store). Thus, the computer system can calculate a scan route, traversable by the robotic system, to: prioritize unscanned locations in the store associated with urgency scores exceeding a threshold urgency score; prioritize previously scanned locations in the store associated with urgency scores exceeding the threshold urgency score; and avoid locations in the store associated with urgency scores falling below the threshold urgency score.

Accordingly, the computer system can calculate a scan route, traversable by the robotic system, to opportunistically scan low-urgency locations in the store (e.g., urgency scores falling below the threshold urgency score) while navigating to high-urgency locations in the store (e.g., urgency scores exceeding the threshold urgency score). Accordingly, the robotic system can image a smaller fraction of extant lower-urgency locations and a larger fraction of extant higher-urgency locations while traversing the scan route. Alternatively, the robotic system can image a small or large fraction of extant lower-urgency locations and image all extant higher-urgency locations while traversing the scan route.

### 4. Robotic System

A robotic system autonomously navigates throughout a store and records images—such as color (e.g., RGB) images of packaged goods and hyper-spectral images of fresh produce and other perishable goods—continuously or at discrete predefined waypoints throughout the store during a scan cycle. Generally, the robotic system can define a network-enabled mobile robot that can autonomously: traverse a store; capture color and/or hyper-spectral images of inventory structure, shelves, produce displays, etc. within the store; and upload those images to the remote computer system for analysis, as described below.

In one implementation, the robotic system defines an autonomous imaging vehicle including: a base; a drive system (e.g., a pair of two driven wheels and two swiveling castors) arranged in the base; a power supply (e.g., an electric battery); a set of mapping sensors (e.g., fore and aft scanning LIDAR systems); a processor that transforms data collected by the mapping sensors into two- or three-dimensional maps of a space around the robotic system; a mast extending vertically from the base; a set of color cameras arranged on the mast; one or more hyper-spectral sensors (or “cameras,” “imagers”) arranged on the mast and configured to record hyper-spectral images representing intensities of electromagnetic radiation within and outside of the visible spectrum; and a wireless communication module that downloads waypoints and a master map of a store from a computer system (e.g., a remote server) and that uploads photographic images captured by the camera and maps generated by the processor to the remote computer system. In this implementation, the robotic system can include cameras and hyper-spectral sensors mounted statically to the mast, such as two vertically offset cameras and hyper-spectral sensors on a left side of the mast and two vertically offset cameras and hyper-spectral sensors on the right side of mast. The robotic system can additionally or alternatively include articulable cameras and hyper-spectral sensors, such as: one camera and hyper-spectral sensor on the left side of the mast and supported by a first vertical scanning actuator; and one camera and hyper-spectral sensor on the right side of the mast and supported by a second vertical scanning actuator. The robotic system can also include a zoom lens, a wide-angle lens, or any other type of lens on each camera and/or hyper-spectral sensor.

In one variation described below, the robotic system further includes a wireless energy/wireless charging subsystem configured to broadcast a signal toward a fixed camera installed in the store in order to recharge this fixed camera. However, the robotic system can define any other form and can include any other subsystems or elements supporting autonomous navigating and image capture throughout a store environment.

Furthermore, multiple robotic systems can be deployed in a single store and can be configured to cooperate to image shelves within the store. For example, two robotic systems can be placed in a large single-floor retail store and can cooperate to collect images of all shelves and produce displays in the store within a threshold period of time (e.g., within one hour). In another example, one robotic system can be placed on each floor of a multi-floor store, and each robotic system can each collect images of shelves and produce displays on its corresponding floor. The remote computer system can then aggregate color and/or hyper-spectral images captured by multiple robotic systems placed in one store to generate a graph, map, table, and/or task list for managing distribution and maintenance of product throughout the store.

### 5. Robotic System Deployment

Once a robotic system is deployed in a store (and once the robotic system executes a first mapping routing to autonomously map the store), the computer system can interface with a user (e.g., a store manager, a robotic system operator)—such as via a user interface with a native application or web interface executing on a desktop computer or mobile device—to configure scan frequencies and scan types executable by the robotic system when autonomously navigating past slots and inventory structure within the store during a first scan cycle (and subsequent scan cycles).

### 6. Preloaded Generic Baselines

In one variation, the method includes: retrieving a generic recommended baseline scan frequency assigned to the product type in Block S130; and accessing a set of locations in the store assigned to the product type in Block S134. Generally, in this variation the computer system links generic recommended baseline scan frequencies and generic recommended scan types—such as defined by brands, distributors, etc. and regardless of specific conditions at or characteristics of the store—to product types stocked in the store.

In one implementation, the computer system: accesses a planogram of the store such as uploaded by a user or from a database linked by the user via the user interface; and extracts a list of all unique product type identifiers (e.g., SKU values) assigned to each slot defined in the planogram. For each product type identifier in this list, the computer system can then: retrieve a generic recommended baseline scan frequency associated with this product type (e.g., once per hour for milk from a first brand; once per two-hour interval for milk from a second brand); retrieve a generic recommended scan type (e.g., product presence, product temperature, and/or produce quality) associated with this product type; identify a location (e.g., an (x,y) position) in the store for each slot assigned to the product type by the planogram; and link the generic recommended baseline scan frequency and the generic recommended scan type for the product type to each of these store locations.

### 6.1 Predefined Baseline Scan Frequencies

For example, the computer system can access a database of recommended baseline scan frequencies, published by a corporate entity affiliated with the store, for a corpus of products stocked in a population of stores including the store. The computer system can then, for a first product type in the set of product types stocked in the store, load a recommended baseline scan frequency—assigned to the first product type—from the database. The computer system can then: present recommended baseline scan frequencies of product types of the set of product types to a user affiliated with the store; and prompt the user to adjust recommended baseline scan frequencies of product types of the set of product types. In response to receiving a first adjusted scan frequency for a first product type from the user, the computer system can overwrite a first recommended baseline scan frequency—assigned to the first product type in the database—with the first adjusted scan frequency specific to the store. The computer system can repeat this process for other product types and adjusted scan frequencies selected by the user.

In another example, the computer system can access a database of recommended baseline scan frequencies published by a manufacturer affiliated with a first product type, in a first subset of product types, in the set of product types. The computer system can then load a recommended baseline scan frequency for the first product type from the database. The computer system can then, for a second product type, in a second subset of product types, in the set of product types: identify a supplier for the product type; access a restocking fulfillment schedule of the supplier to the store; extract a time interval between a first scheduled restocking period and a second scheduled restocking period from the restocking fulfillment schedule; and calculate a baseline scan frequency for the product type based on the time interval. The computer system can repeat this process for all other product types stocked in the store. Therefore, in the foregoing examples, the computer system can: retrieve predefined baseline scan frequencies for product types stocked in the store, such as published by product manufacturers, a parent entity of the store, a supplier or wholesaler, and/or an external restocking entity, etc.; automatically assign these baseline scan frequencies to these product types; and interface with the user (e.g., a store manager or associate) to selectively modify scan frequencies for particular product types—such as based on the user's needs or interests.

Thus, the computer system can rapidly onboard baseline scan frequencies for product types in the store based on extant scan frequency data and then interface with the user to quickly “tune” these scan frequencies for particular product types specifically for the store.

### 6.2 Predefined Baseline Scan Frequency and Scan Type by Product Category

In a similar implementation, the computer system can access the planogram and extract the list of unique product type identifiers assigned to slots in the store, as described above. Then, for each product type identifier in this list, the computer system can: identity a product category of the product type (e.g., dairy, fresh produce, cleaning supply, or camping gear, etc.); retrieve a generic recommended baseline scan frequency for the product category of the product type (e.g., once per hour for dairy products; once per two-hour interval for fresh produce; once per day for cleaning supplies; once per week for camping gear); retrieve a generic recommended scan type for the product category; identify a location in the store for each slot assigned to the product type by the planogram; and link the generic recommended baseline scan frequency and the generic recommended scan type for the product category to each of these store locations.

For example, in these implementations, a generic recommended baseline scan frequency and a generic recommended scan type for a product type can be published by a brand, a distributor, a regulatory body, and/or a corporate entity affiliated with the store, etc. The computer system can therefore retrieve a generic recommended baseline scan frequency and a generic recommended scan type for a particular product type from a corresponding public or private database.

In another example, the computer system can access a set of a scan types. Then, for a first product type—in the set of product types—representing a frozen packaged good, the computer system can retrieve a first scan type prescribing a temperature check from the set of scan types and assign the first scan type to the first product type. The computer system can then, for a second product type—in the set of product types—representing a fresh produce product: retrieve a second scan type prescribing a quality check from the set of scan types; and assign the second scan type to the second product type. The computer system can then, for a third product type—in the set of product types—representing a high sell-through rate good characterized by a sell-through rate greater than a threshold rate: retrieve a third scan type prescribing a stock check from the set of scan types; and assign the third scan type to the third product type. The computer system can repeat this process for the other scan types in the set of scan types and all other product types in the set of product types.

Therefore, the computer system can perform specialized scan types to scan product categories for an additional attribute—such as temperature sensitivity or the tendency to spoil—and record the attribute as a metric. The computer system can also perform a specialized scan type to scan a product category that exhibits a specific trend, such as a high sell-through rate, and perform a scan type to capture data that more accurately depicts this trend.

In another example, the computer system can access a predefined set of baseline scan frequency rules based on product category and sale rate for the store. The computer system can then, for a first product type—in the set of product types—representing a frozen packaged good: retrieve a first baseline scan frequency of approximately twice per day for frozen packaged goods from the set of baseline scan frequency rules; and assign the first baseline scan frequency to the first product type. The computer system can then, for a second product type—in the set of product types—representing a fresh produce product: retrieve a second baseline scan frequency of approximately once per day for fresh produce product from the set of baseline scan frequency rules; and assign the second baseline scan frequency to the second product type. The computer system can then, for a third product type—in the set of product types—representing a first canned good characterized by a sale rate greater than a threshold sale rate: retrieve a third baseline scan frequency of approximately once per two-day interval for a canned good at a first sale rate from the set of baseline scan frequency rules; and assign the third baseline scan frequency to the third product type. The computer system can, for a fourth product type—in the set of product types—representing a second canned good characterized by sale rate less than a threshold rate: retrieve a fourth baseline scan frequency of approximately once per week for canned goods at a second sale rate, less than the first sale rate, from the set of baseline scan frequency rules; and assign the fourth baseline scan frequency to the fourth product type. The computer system can repeat this process for the other product types in the set of product types.

Therefore, the computer system can assign a baseline scan frequency to a product type based on a set of rules for that product type.

### 7. Derived Generic Baselines

In another variation, the computer system derives recommended baseline scan frequencies and recommended scan types for product types stocked in the store based on the characteristics of the store and scan frequencies and scan types previously implemented at other stores.

In one implementation, the computer system can access the planogram and extract the list of unique product type identifiers assigned to slots in the store, as described above. The computer system can then predict a type of the store based on these product types, such as: a grocery store if this list contains identifiers for packaged foods, dairy products, fresh produce, cleaning supplies, and cooking supplies, etc.; a sporting goods store if this list contains identifiers for camping gear, fishing supplies, footwear, etc.; or a general dry goods (or “supercenter”) store if this list contains identifiers for packaged food, dairy, fresh produce, cleaning supplies, cooking supplies, camping gear, lawn and garden materials and equipment, toys, etc. Upon predicting a type of the store, the computer system can retrieve baseline scanning frequencies implemented at other stores of the same or similar type and merge these baseline scanning frequencies to calculate recommend scan frequencies for product types stocked within the store. For example, the computer system can retrieve scanning profiles from the set of stores of the same type, wherein each scanning profile specifies scanning frequencies and scan types implemented within one of these other stores for all product types stocked in this other store. The computer system can then weight these scanning profiles based on relevance to the store, such as proportional to proximity to the store. Then, for each product type stocked in the store, the computer system can: calculate a combination (e.g., a weighted average) of the scanning frequencies implemented at each of these other stores for this same product type, weighted by the weights of the corresponding stores; store this combination as a recommended baseline scan cycle for the product type; identify a scan type implemented with greatest frequency—weighted by corresponding store weight—across this set of stores; store this scan type as a recommended baseline scan type for the product type; identify a location (e.g., an (x,y) position) in the store for each slot assigned to the product type by the planogram; and link the recommended baseline scan frequency and the recommended scan type for the product type to each of these store locations.

In this implementation, the computer system can implement similar methods and techniques to derive recommended baseline scan frequencies and baseline recommended scan types for product categories—rather than for individual product types—based on scanning profiles implemented by other stores of the same type.

In a similar implementation, for each other store in a total population of stores, the computer system can calculate a similarity score representing similarity between this other store and the store, such as based on: (e.g., proportional to) overlap of product types carried by the store and the other store; geographic proximity; and/or similarity in annual sales volume. Then, for each product type in the list of product types specified in the planogram of the store, the computer system can implement methods and techniques descried above to: calculate a combination (e.g., a weighted average) of the scanning frequencies implemented at each of these other stores for this same product type, weighted by the similarity scores of the corresponding stores; store this combination as a recommended baseline scan cycle for the product type; identify a scan type implemented with greatest frequency—weighted by corresponding store weight—across this set of stores; store this scan type as a recommended baseline scan type for the product type; identify a location in the store for each slot assigned to the product type by the planogram; and link the recommended baseline scan frequency and the recommended scan type for the product type to each of these store locations.

However, the computer system can implement any other method or technique to retrieve or generate recommended baseline scanning frequencies and/or scan types for particular product types or product categories—specified in the planogram of the store—based on extant product, product category, or store data from other stores.

### 8. Store-Specific Auto-Generated Baselines

In another variation, the computer system calculates baseline scan frequencies for slots throughout the store based on the store's historical sales data.

In one implementation, the computer system: accesses a planogram of the store such as uploaded by a user or from a database linked by the user via the user interface; extracts a list of all unique product type identifiers (e.g., SKU values) assigned to each slot defined in the planogram; and accesses historical sales data for the store, such as quantity of units of each product type sold per unit time (e.g., per hour, per day, per week, per year). For each product type identifier in this list, the computer system can then: extract a total count of product units of the product type sold within a time window (e.g., one hour, one day, one week, one month, one season, one year) from the historical sales data; divide this total count of sold product units by the duration of the time window to calculate total sale rate of the product type; count a quantity of unique slot addresses assigned to this product type by the planogram; and divide the total sale rate of the product type by this count of unique slot addresses to calculate an estimated sale rate from each slot assigned to the product type.

Then, for each slot assigned to the a particular product type, the computer system can: extract—from the planogram—a quantity of product units of the particular product type assigned to the slot (i.e., a quantity of product units of the particular product type designating a fully-stocked state of the slot); divide the assigned quantity of product units by the estimated sale rate per slot assigned to the particular product type to calculate an estimated time to empty the slot; and calculate baseline scan frequency based on the estimated time to empty the slot and baseline minimum stock condition. For example, to ensure that a slot is rescanned before the stock condition of the slot drops below 50%, the computer system can assign a baseline scan frequency equal to twice the inverse of the estimated time to empty the slot. The computer system can then link this baseline scan frequency to each slot assigned the particular product type identifier by the planogram. The computer system can then repeat this process for each other slot and product type in the store.

Furthermore, in this implementation, for each product type, the computer system can derive an average sale rate of the product type—from each slot assigned to this product type—as a function of time (e.g., time of day, day of week, season, and/or time of year). Then, for each slot assigned to this product type, the computer system can implement methods and techniques described above to: calculate a variable sale rate from the slot; calculate a variable time to empty each slot; and generate a variable baseline scan frequency for the slot as a function of time (e.g., during particular four-hour time blocks, on particular days of the week, during particular weeks of the month, during particular months, and/or during particular seasons).

For example, the computer system can: retrieve a scan frequency assigned to a first product type; access a first sale rate of the first product type—within a time interval prior to the scan cycle—from a point-of-sale system affiliated with the store; retrieve a first quantity of product facings of the first product type assigned to a set of slots within the store; and calculate a first scan frequency for the first product type proportional to the first sale rate of the first product type and inversely proportional to the first quantity of product facings of the first product type within the store. The computer system can repeat this process for the other product types in the set of product types stocked in the store.

Thus, the computer system can automatically generate a baseline scan frequency in real-time for a first product type based on store-specific data retrieved from a system affiliated with the store, such as sell-through rate retrieved from the point-of-sale system, as opposed to accessing and applying a first predefined baseline scan frequency to a first product type.

In another implementation, the computer system can retrieve and interpret a stock-check schedule for store, such as specifying: scheduled times—within an hourly, daily, or weekly time window—of manual stock reviews of particular slots, product types, product categories, or sections within the store; and stock check types (e.g., product presence, temperature, and/or produce quality checks) for these slots, product types, product categories, or sections within the store. Then, for each slot in the store, the computer system can implement methods and techniques described above to: retrieve a location of the slot in the store (e.g., from the planogram); identify a particular product type assigned to this slot by the planogram; identify or retrieve a product category of the particular product type; scan the stock-check schedule for scheduled times of manual review of the slot, the particular product type, the product category, and/or the section of the store containing the slot; aggregate a count of these scheduled times; and divide this count by a duration of the time window specified by the stock-check schedule to calculate a scan frequency for this slot. Similarly, for each slot in the store, the computer system can implement methods and techniques described above to: scan the stock-check schedule for manual review types assigned to the slot, the particular product type, the product category of the product type, and/or the section of the store containing the slot; and aggregate these scan types into a scan type specification. The computer system can then link these derived scan frequencies and derived scan types to each slot.

### 8.1 Recursively Derived Baseline Scan Frequency

In another implementation, the computer system can: retrieve a first scan frequency assigned to a first product type in the set of product types; identify a first location in the store assigned to the first product type; access a first stock condition of the first location derived from a first set of images captured by the robotic system during a first scan cycle preceding a current scan cycle; access a second stock condition of the first location derived from a second set of images captured by the robotic system during a second scan cycle following the first scan cycle and preceding the current scan cycle; calculate a first rate of change of the first location based on the first stock condition and the second stock condition; and set a second scan frequency for the product type at the first location based on the rate of change. The computer system can repeat this process for the other product types in the set of product types.

Thus, rather than accessing and applying a first predefined baseline scan frequency to a first product type, and rather than deriving a first baseline scan frequency based on store-specific data from a system affiliated with the store, the computer system can calculate a first baseline scan frequency for a first product type based on data collected by the computer system (and robotic system).

For example, the computer system can: access a first previously-completed scan cycle including a first stock condition of a first product; access a second previously-completed scan cycle including a second stock condition of the first product; and detect a difference between the first stock condition and the second stock condition. The computer system can retrieve a first time of completion of the first scan, and a second time of completion of the second scan and calculate a time duration as a difference between the first time of completion and the second time of completion. The computer system can then set a baseline scan frequency for the first product type based on this time duration corresponding to a change in the stock condition of the first product type. The computer system can repeat this process to recalculate the baseline scan frequency for the first product type for any subsequent scan cycle. The computer system can also predict a future difference and/or rate of change of stock by calculating a trend curve or curve of best fit derived from a set of previously completed scan cycles. The computer system can repeat this process for all other product types stocked in the store. The computer system can also execute these steps for other changes detected by the computer system (or robotic system) regarding a first product type while scanning the store, such as temperature or quality changes.

### 9. Baseline Adjustments

One variation of the method S100 includes: annotating a map of the store according to generic recommended baseline scan frequencies and locations of the set of product types in Block S140; presenting the map to a user affiliated with the store in Block S142; and overwriting a first baseline scan frequency of a first product type, assigned to a first location in the store, based on a first input from the user in Block S144. Generally, in this variation, the computer system can interface with the user to adjust the baseline scan frequency and/or scan type thus automatically assigned to individual product types, groups of product types, whole product categories, individual slots, and/or groups of slots, etc. in the store.

9.1 Baseline Adjustment within Store Plan Map

In one implementation, the computer system renders: a store plan map depicting locations and plan views of inventory structures throughout the store within the user interface; and overlays the store plan map with a heatmap (e.g., a visual gradient) representing baseline scan frequencies assigned to slots throughout the store.

For example, the computer system can set a pixel in the heatmap to a color according to the maximum scan frequency of a set of slots (e.g., multiple adjacent columns of slots in an inventory structure given at a low map zoom level; one column of slots in an inventory structure given a high map zoom level) occupying an (x,y) location in the store represented by the pixel. In another example, for each pixel in the heatmap, the computer system can: calculate a composite scan frequency based on an average scan frequency of all slots in the store (or all slots in the nearest inventory structure or aisle), weighted by distance from each slot to the area in the store represented by the pixel; and color the pixel according to this composite scan frequency.

The computer system can present the store plan map—annotated with the heatmap—to the user, thereby enabling the user to quickly, visually perceive recommended scanning frequencies throughout the store. Then, if the user identifies an (x,y) location assigned a scan frequency different from the user's expectation or predicted need, the user may select this location (e.g., corresponding to a shelving segment or to a column of slots) or draw a bounding perimeter around the location (e.g., around a shelving structure, an aisle, or a section of the store) on the map and adjust the scan frequency assigned to this location. For example, the computer system can adjust the scan frequency assigned to slots intersecting (and near) this (x,y) location in the store in response to the user moving a slider within the user interface when this location is selected within the user interface.

In another example, the computer system can: receive a first input from the user, linking a first baseline scan frequency of the first product type to a sell-through rate of the first product type; calculate a revised scan frequency of the first product type inversely proportional to the sell-through rate of the first product type published by a point-of-sale system in the store; and overwrite the first baseline scan frequency of the first product type—in the map—according to the revised scan frequency. The computer system can repeat this process for other product types in the set of product types and other scan frequencies in the set of scan frequencies

Thus, the computer system can adjust the scan frequency of a single product type (or a set of product types) based on input from a user. By incorporating input from a user, the computer system can modify the scan route and schedule of the robotic system based on changes in the store communicated by the user.

Similarly, the computer system can generate a set of scan type layers aligned to the plan map of the store. For example, for a product presence scan layer, the computer system can set a pixel in this layer to a first, non-transparent color value (e.g., green, 40% opacity) if at least one slot in a column of slots (for a high map zoom level) or a cluster of slots (for a lower map zoom level)—occupying an (x,y) location in the store represented by the pixel—is assigned a product presence scan type. Conversely, the computer system can set a pixel in this layer to a transparent color value (e.g., no color, 0% opacity) if all slots—occupying an (x,y) location represented by the pixel—are not assigned a product presence scan type.

Similarly, for a temperature scan layer, the computer system can set a pixel in this layer to a second, non-transparent color value (e.g., blue, 40% opacity) if at least one slot in a column or cluster of slots—occupying an (x,y) location in the store represented by the pixel—is assigned a temperature scan type. Conversely, the computer system can set a pixel in this layer to a transparent color value (e.g., no color, 0% opacity) if all slots—occupying an (x,y) location represented by the pixel—are not assigned a temperature scan type.

Furthermore, for a produce quality scan layer, the computer system can set a pixel in this layer to a third, non-transparent color value (e.g., red, 40% opacity) if at least one slot in a column or cluster of slots—occupying an (x,y) location in the store represented by the pixel—is assigned a produce quality scan type. Conversely, the computer system can set a pixel in this layer to a transparent color value (e.g., no color, 0% opacity) if all slots—occupying an (x,y) location represented by the pixel—are not assigned a produce quality scan type.

The computer system can then: enable the user to view these heatmap layers over the store plan map and thus view locations in the store in which different baseline scan types are activated; enable the user to select a pixel in a heatmap layer—and thus a corresponding column or cluster of slots; enable the user to toggle scan types activated for slots represented by this pixel; and then update scan type assignments for these slots accordingly.

9.2 Baseline Adjustment within Planogram

In a similar implementation, the computer system can: retrieve a planogram elevation representing an inventory structure (e.g., a shelving structure or shelving segment); and overlay the planogram elevation with a heatmap representing baseline scan frequencies assigned to slots within this inventory structure.

For example, the computer system can implement methods and techniques described above: to set a pixel in the heatmap to a color according to the scan frequency assigned to a slot occupying an (x,z) location on the inventory structure represented by the pixel; and to present the planogram elevation—annotated with the heatmap—to the user, thereby enabling the user to quickly, visually perceive recommended scanning frequencies along this inventory structure.

Then, if the user identifies a slot assigned a scan frequency different from the user's expectation or predicted need, the user may select the slot or draw a bounding perimeter around a group of slots and adjust the scan frequency assigned thereto. For example, the computer system can adjust the scan frequency assigned to one or a selected group of slots in response to the user moving a slider within the user interface when these slots are thus selected by the user.

Similarly, the computer system can implement methods and techniques described above: to generate a set of scan type layers aligned to the planogram elevation; to present the planogram elevation—selectively annotated with these layers—to the user to enable the user to quickly, visually perceive recommended scanning types along this inventory structure; and to update scan types assigned to slots in this inventory structure in response to adjustments entered by the user via the user interface.

9.2 Baseline Adjustments within Spreadsheet

In another implementation, the computer system: aggregates a product type identifier, a product type description, a slot address, a scan frequency, and a scan type for each product type (or for each slot) indicated in the planogram into a list (e.g., a spreadsheet); presents this list to the user via the user interface; and prompts or enables the user to manually adjust the scan frequency and scan type for each individual product type (or slot), such as by directly modifying values contained in the list or via dropdown menus within the list.

In this implementation, the computer system can also enable the user to: sort and group product types (or slots) in the list, such as by location (e.g., store section, aisle, shelving structure, shelving segment), product category, sale rate, or brand; and then adjust the scan frequency and scan type for these groups of product types (or groups of slots).

### 9.4 Baseline Adjustments: Baseline Scan Frequency by Historical Sales Data

In the variation described above in which the computer system calculates a baseline scan frequency for each slot based on historical sales data from the store, the computer system can: select a recommended baseline minimum stock condition of a slot before rescanning (e.g., 50%, as described above); and calculate a baseline scan frequency for the slot accordingly. However, in this variation, the computer system can also prompt or enable the user to adjust this minimum stock condition, such as: for each individual slot in the store; for all slots assigned to a particular product type; for all slots assigned to product types within a particular product category; or generally for all slots in the store.

Additionally or alternatively, in this implementation, the computer system can automatically adjust the minimum stock condition for a particular slot based on proximity of other slots assigned to the same product type. For example, for a slot assigned to a particular product type by the planogram, the computer system can: extract a distance from this slot to each other slot assigned to the same product type, such as from the planogram or map of the store; and calculate a minimum stock condition for the slot proportional to the distance to another slot assigned to the same product type and/or inversely proportional to the quantity of other slots assigned to the same product type. For example, the computer system can assign: a low minimum stock condition (e.g., 10%) to a slot if this slot is located within a cluster of six slots assigned to the same product type; a higher minimum stock condition (e.g., 35%) to a slot if the planogram specifies only one other slot—on the other side of store—assigned to the same product type; and a highest minimum stock condition (e.g., 50%) to a slot if this slot is the only slot in the store assigned to a particular product type.

The computer system can then prompt the user to confirm these minimum stock conditions for slots in the store. For example, the computer system can implement methods and techniques described above to generate a heatmap of minimum stock conditions and to present this heatmap—overlaid over the store plan map or planogram elevation—to the user.

### 10. Other Scan Metrics

In one variation, the computer system implements methods and techniques described above to recommend, derive, and/or adjust a maximum time between consecutive scans for a particular product type, slot, shelf, shelving segment, shelving structure, aisle, product category, and/or store section—such as rather than or in addition to recommending, deriving, and/or adjusting a scan frequency (i.e., a minimum number of scans within a time window).

Similarly, the computer system can implement methods and techniques described above to recommend, derive, and/or adjust a scanning priority for a particular product type, slot, shelf, shelving segment, shelving structure, aisle, product category, and/or store section. The computer system can then calculate a scan frequency—for a particular product type, slot, shelf, shelving segment, shelving structure, aisle, product category, and/or store section—proportional to this priority. Additionally or alternatively, the computer system can calculate a maximum time between scans—of a particular product type, slot, shelf, shelving segment, shelving structure, aisle, product category, and/or store section—inversely proportional to priority.

### 11. Manual Scan Frequency and Scan Type

Alternatively, the computer system can interface with the user to manually annotate the store plan map or a planogram elevation with scan frequencies, maximum times between scans, and/or scan priorities for particular: product categories; aisles; shelving structures; shelving segments; shelves; slot clusters; and/or individual slots.

### 12. Variable Scan Parameters

In foregoing variations, the computer system can assign preloaded or derived “fixed” (i.e., constant) baseline scan parameters to product types. Alternatively, the computer system can implement similar methods and techniques to access or derive variable baseline scan parameters for product types, such as based on: time of day; day of week; season or time of year; and/or an upcoming or current holiday. More specifically in the foregoing variations, the computer system can implement the foregoing methods and techniques a) to derive, recommend, and adjust b) variable scan frequencies, maximum times between scans, scan priorities, and/or scan types c) for individual product types, product categories, individual slots, clusters of slots, and/or store sections d) as a function of time of day, day of week, month, season, store occupancy, and/or sale rate, weather condition, etc.

For example, the computer system can: assign a low recommended baseline scan frequency to camping goods during a winter season except for the last two weeks of December; and assign a high recommended baseline scan frequency for these camping goods during a summer season.

In another example, the computer system can: select a first combination of conditions (e.g., a most common or current time of day, day of week, relevant holiday season, store occupancy); and then implement methods and techniques described above to derive, recommend, and adjust a first set of scan parameters for individual product types, product categories, individual slots, clusters of slots, and/or store sections given this first combination of conditions. In this example, the computer system can similarly: select a second combination of conditions (e.g., corresponding to a time window exhibiting highest sales volume in past four weeks); and then implement methods and techniques described above to derive, recommend, and adjust a second set of scan parameters for individual product types, product categories, individual slots, clusters of slots, and/or store sections given this second combination of conditions. The computer system can also: repeat this process for additional combinations of conditions and sets of scan parameters; and interpolate between these discrete combinations of conditions to derive additional sets of scan parameters for individual product types, product categories, individual slots, clusters of slots, and/or store sections.

Additionally or alternatively, the computer system can activate variable scan frequencies for all or particular product types, product categories, clusters of slots, individual slots, and/or store sections based on real-time sale rates of corresponding product types. For example, the computer system can increase a scan frequency assigned to a particular slot—from its baseline scan frequency—if the real-time sale rate of a particular product type assigned to this slot exceeds a running historical average sale rate or an historical average sale rate under current conditions for this product type.

### 12. Other Temporal Scan Parameters

The computer system can also interface with the user to define operational time windows in which the robotic system is permitted to operate within the store (e.g., all day, 6-10 AM, 2-5 PM on weekdays).

Additionally or alternatively, the computer system can interface with the user to define conditions in which the robotic system is not permitted to operate in the store, such as: when more than a threshold quantity of customers are present in the store; if less than a threshold sale volume has occurred in the store since a last scan cycle completed by the robotic system; or if an aggregate score (described below) for all slots in the store is less than a threshold aggregate score.

Similarly, the computer system can also interface with the user to define non-operational time windows in which the robotic system is not permitted to operate within the store, such as: holidays; Friday afternoons; and Saturday mornings (each of which may be characterized by high customer traffic).

The computer system can also retrieve and load such temporal scan parameters from a corporate database affiliated with the store or implement methods and techniques similar to those described above to derive and recommend operational time windows for the store based on operational time windows implemented in other stores of similar store types, stocked with similar products, and/or in a similar geographic region.

### 14. Restocking Times

In one variation, the computer system can also: access a schedule of restocking periods in the store; and interpret final times to return global restocking lists—specifying slots in the store to restock—based on these start times of restocking periods specified in this schedule.

In one example in which the restocking schedule specifies a single daily restocking period starting at 11 PM, the computer system can determine that all slots assigned a scan frequency of once per day (i.e., a maximum time of 24 hours between consecutive scans) should be scanned by the robotic system during a scan cycle and prior to 11 PM on the current day if not otherwise scanned since 11 PM on the previous day. In this example, the computer system can similarly determine: that all slots assigned a scan frequency of once per two-day interval (i.e., a maximum time of 48 hours between consecutive scans) should be scanned by the robotic system during the scan cycle on the current day if not scanned on the previous day; and that slots in this set that were scanned on the previous day may be disregarded during a scan cycle on the current day if not otherwise accessible by the robotic system (e.g., blocked by a customer). Furthermore, the computer system can similarly determine: that all slots assigned a scan frequency of once per week (i.e., a maximum time of 168 hours between consecutive scans) should be scanned by the robotic system and prior to 11 PM during the scan cycle on the current day if not scanned in the past week; and that slots in this set already scanned within the past week may be disregarded during a scan cycle on the current day if not otherwise accessible by the robotic system.

Therefore, the computer system can: identify slots necessary for the robotic system to scan during an upcoming scan cycle in order to fulfill scan frequencies assigned to these slots; and identify slots that may be disregarded (or “skipped) by the robotic system during the upcoming scan cycle because scan frequencies assigned to these slots were fulfilled during a previous scan cycle.

### 14.1 Stock Condition Output

The computer system can also interface with the user to transmit stock conditions in the store in real time or on a time delay (e.g., after a scan cycle is completed). The computer system can redirect the robotic system based on the derived stock condition in the store by recalculating the route of the robotic system mid-scan.

For example, after initiating the scan cycle and during a first time period within the scan cycle, the robotic system can: autonomously navigate along a first scan route; and capture a first series of images of a first set of product units occupying a first set of inventory structures proximal the first scan route. The robotic system can then, during a second time period within the scan cycle: autonomously navigate along a second scan route; and capture a second series of images of a second set of product units occupying a second set of inventory structures proximal the second scan route. The computer system can then derive a first set of stock conditions in the first set of inventory structures within the store—during the scan cycle—based on features detected in the first series of images. The computer system can then derive a second set of stock conditions in the second set of inventory structures within the store—during the scan cycle—based on features detected in the second series of images. The computer system can then retrieve a third set of stock conditions—of a third set of product units occupying a third set of inventory structures within the store—derived from features detected in a third series of images captured by the robotic system during a set of scan cycles within the store preceding the current scan cycle. The computer system can then compile the first set of stock conditions, the second set of stock conditions, and the third set of stock conditions into a global inventory representation of the store. The computer system can repeat this process for the other product types in the set of product types.

Thus, the computer system can automatically compile stock conditions for a single product type, a subset of product types, or a global set of product types stocked in a store by analyzing data collected by the robotic system deployed in the store. The computer system can compile a stock condition by incorporating data from a single scan cycle, or by incorporating data from multiple scan cycles.

In a related example, the computer system can access an inventory map of the store and, for a first slot in a set of slots in the inventory map corresponding to a first product unit in a first set of product units, annotate the first slot of the inventory map with the time of the last inventory check of the first slot, and a stock condition of the first slot, at the time of the last inventory check. The computer system can then: compile the stock condition corresponding to the first slot in the annotated inventory map into a global stock condition of the store; present the annotated inventory map and the global stock condition to a user; and prompt the user to confirm the accuracy of the annotated inventory map and the global stock condition of the store. The computer system can repeat this process for all other product types in the set of product types and all other slots in the set of slots.

Thus, the computer system can interface with the user to transmit stock conditions in the store in real time and prompt the user to confirm stock conditions within the store.

### 15. Slot Prioritization

In preparation for an upcoming scan cycle, the remote computer system (or the robotic system) can rank (or “score”) individual slots for scanning by the robotic system during the upcoming scan cycle based on: scan frequencies assigned to these slots; times that these slots were last scanned by the robotic system; current conditions in the store; and/or time until a next scheduled daily restocking period.

In one implementation, the computer system can calculate a score for a slot inversely proportional to the duration of time remaining to scan the slot before failing to fulfill the scan frequency assigned to this slot (or calculated for this slot given current conditions in the store). For example, for a first slot in the store, the computer system can: retrieve a time that the first slot was last scanned by the robotic system; read a current time; and retrieve a scan frequency and/or maximum time between consecutive scans assigned to the first slot (or calculate these values for the slot given real-time conditions in the store). If the difference between the current time and the time of the last scan of the slot exceeds the maximum time between consecutive scans, the computer system can calculate a highest score (e.g., “100/100”) to the first slot. If this difference is minimally (e.g., 30 minutes) less than the maximum time between consecutive scans, the computer system can calculate a very high score (e.g., “95/100”) for the first slot. If this difference is slightly (e.g., two hours) less than the maximum time between consecutive scans, the computer system can calculate a high score (e.g., “80/100”) for the first slot. If this difference is moderately (e.g., eight hours) less than the maximum time between consecutive scans, the computer system can calculate a moderate score (e.g., “60/100”) for the first slot. If this difference is much (e.g., two days) less than the maximum time between consecutive scans, the computer system can calculate a low score (e.g., “20/100”) for the first slot. If this difference is exceedingly (e.g., five days) less than the maximum time between consecutive scans, the computer system can calculate a minimal score (e.g., “1/100”) for the first slot. The computer system can then repeat this process for each other slot in store.

In one variation, when the robotic system is not executing a scan cycle, the remote computer system can execute this process to recalculate scores for slots throughout the store, such as once per minute or once per 20-minute interval. Once a sum of scores for all slots in the store exceeds a threshold aggregate score, the remote computer system can trigger the robotic system to initiate a scan cycle.

Additionally or alternatively, the remote computer system can trigger the robotic system to initiate a scan cycle responsive to another trigger (e.g., traffic in the store exceeding a threshold customer count) or at a pre-scheduled scan time.

As described below, the remote computer system and/or the robotic system can also implement similar methods and techniques to recalculate scores for slots throughout the store in real-time, such as to account for slots scanned by the robotic system during a current scan cycle and/or for changing conditions in the store.

### 16. Calculation of Scan Route

Generally, the remote computer system (or the robotic system) can calculate a continuous route—from the robotic system's dock, through the store, and back to the dock—that, when traversed by the robotic system, maximizes the sum of current scores of slots scanned by the robotic system (e.g., fall within the sensible field of the robotic system) per consecutive unit distance along the route traversed by the robotic system.

Furthermore, the computer system can calculate this route that: remains within the bounds of the store; avoids collisions with known areas of fixed inventory structures throughout the store; and falls within a range of distances (e.g., 2-4 feet) from adjacent inventory structures to enable the robotic system to scan (e.g., capture photographic images of) the full height of these inventory structures with features of product units on these inventory structures captured with at least a minimum resolution.

The computer system can then upload this scan route to the robotic system for execution during the upcoming scan cycle.

16.1 Prioritization of Slots with Higher Urgency Scores

Generally, the computer system can calculate a scan route, traversable by the robotic system, that preferentially locates—within the field of view of the robotic system—locations of slots in the store associated with higher urgency scores over locations of slots in the store with lower urgency scores, as shown in FIGS. 2 and 3.

In one implementation, the computer system: identifies a first set of locations in the store associated with a first set of urgency scores such that each urgency score in the first set of first urgency scores is greater than a threshold urgency score; and identifies a second set of locations in the store associated with a second set of urgency scores such that each urgency score in the second set of first urgency scores is less than the threshold urgency score. Then, for each location in the first set of locations, the computer system defines a waypoint that, when occupied by the robotic system, locates the location within the field of view of an optical sensor arranged on the robotic system. The computer system then: generates a scan route that minimizes a traversal length between a set of waypoints defined for the first set of locations; and transmits the scan route to the robotic system for execution.

Accordingly, during the scan cycle, the robotic system navigates along the scan route to sequentially occupy each waypoint and capture an image of each corresponding location associated with the waypoint and opportunistically captures a series of images of the second set of locations in the store, associated with the second set of urgency scores (e.g., less than the threshold urgency score), while navigating between the set of waypoints along the scan route.

For example, the computer system can: retrieve a set of highest urgency scores, associated with a set of slots, on an inventory structure in the store; in response to the set of highest urgency scores exceeding a threshold urgency score, generate a first set of waypoints proximal the inventory structure; retrieve a set of high urgency scores, associated with a second set of slots, on this inventory structure in the store; in response to the set of high urgency scores falling below the threshold urgency score, retrieve a second set of highest urgency scores, associated with a third set of slots, on a second inventory structure adjacent the first inventory structure; and, in response to the set of next-highest urgency scores exceeding the threshold urgency score, generate a second set of waypoints proximal the second inventory structure. The computer system can then: compile the first set of waypoints and the second set of waypoints into a scan route; and upload the scan route to the robotic system for execution.

Therefore, the computer system can calculate a scan route, traversable by the robotic system, that prioritizes locations in the store associated with urgency scores of slots exceeding the threshold urgency score and omits locations associated with urgency scores of slots falling below the threshold urgency score. The computer system can thus enable the robotic system to scan all slots associated with the highest urgency scores in the store.

16.2 Opportunistic Scan of Slots with Lower Urgency Scores

Furthermore, the computer system can calculate a scan route, traversable by the robotic system, to opportunistically scan locations of slots associated with low-urgency scores while navigating to locations of slots associated with high-urgency scores in the store. The robotic system can thus, image a smaller fraction of extant lower-urgency locations and a larger fraction of extant higher-urgency locations while traversing the scan route. Alternatively, the robotic system can image a small or large fraction of extant lower-urgency locations and image all extant higher-urgency locations while traversing the scan route.

In one implementation, the computer system: identifies a first set of locations in the store associated with a first set of higher-urgency scores (e.g., urgency scores greater than the threshold urgency score); identifies a second set of locations in the store associated with a second set of lower-urgency scores (e.g., urgency scores less than the threshold urgency score); and generates a scan route traversable by the robotic system to locate, within the field of view of the robotic system, the first set of locations in the store associated with the first set of higher urgency scores and to minimize a traversal length between the first set of locations in the store; and transmits the scan route to the robotic system for execution. Accordingly, during the scan cycle, the robotic system: navigates along the scan route to sequentially capture a series of images of the first set of locations in the store; and opportunistically captures a series of images of the second set of locations in the store, associated with the lower-urgency scores, while navigating between the first set of locations along the scan route.

In the foregoing example, the computer system can: retrieve the set of high urgency scores, associated with the second set of slots, on the first inventory structure in the store; and, in response to the set of high urgency scores falling below the threshold urgency score and in response to the set of high urgency scores falling within a threshold distance of the first set of waypoints, generate a second set of waypoints proximal the first inventory structure. The computer system can then: retrieve the second set of highest urgency scores, associated with the third set of slots, on the second inventory structure adjacent the first inventory structure; and, in response to this set of highest urgency scores exceeding the threshold urgency score, generate a third set of waypoints proximal the second inventory structure. The computer system can then: compile the first set of waypoints, the second set of waypoints, and the third set of waypoints into a scan route; and transmit the scan route to the robotic system for execution.

Therefore, the computer system can calculate a scan route that enables the robotic system to scan high-urgency locations of slots on the first inventory structure and opportunistically scan lower-urgency locations of slots on the first inventory structure while navigating to the high-urgency locations of slots on the second inventory structure. Additionally, the computer system can calculate a scan route that enables the robotic system to opportunistically scan locations of slots associated with low-urgency scores while navigating between locations of slots associated with high-urgency scores in the store rather than omitting these locations of slots associated with low-urgency scores.

### 17. Real-Time Scan Route Changes

Once the robotic system initiates this scan cycle, the robotic system can: traverse the planned route; scan slots (e.g., by capturing photographic images of these slots, capturing hyperspectral images of these slots, querying RFID tags on product units occupying these slots, and/or downloading temperature data from temperature sensors coupled to these slots) according to the scan types assigned to these slots; and locally interpret stock conditions in the slots or upload these scans to the computer system for interpretation.

The remote computer system and/or the robotic system can also update records with times that these slots were last scanned and update scores for these slots accordingly. More specifically, after the robotic system scans a particular slot, the remote computer system or the robotic system can calculate a reduced score for this slot. For example, for a slot assigned a scan frequency of once per two-hour interval, the computer system can reduce the score of this slot from 95/100 to 80/100 immediately after the robotic system scans this slot. For a slot assigned a scan frequency of once per eight-hour interval, the computer system can reduce the score of this slot from 92/100 to 60/100 immediately after the robotic system scans this slot. For a slot assigned a scan frequency of once per two-day interval, the computer system can reduce the score of this slot from 87/100 to 20/100 immediately after the robotic system scans this slot. For a slot assigned a scan frequency of once per five-day interval, the computer system can reduce the score of this slot from 72/100 to 1/100 immediately after the robotic system scans this slot.

The computer system (or the robotic system) can also recalculate the route in real-time based on these revised slot scores.

For example, the computer system can: calculate a second scan route including waypoints proximal the second set of inventory structures in response to second urgency scores of a second subset of locations corresponding to the second set of inventory structures exceeding a threshold urgency score. The computer system can then calculate the second scan route omitting waypoints proximal the third set of inventory structures in response to second urgency scores of a third subset of locations corresponding to the third set of inventory structures falling below the threshold urgency score. The computer system can repeat this process for the other product types in the set of product types.

Therefore, the computer system can automatically adjust the scan route of the robotic system to preferentially avoid locations assigned a lower-urgency score in favor of locations assigned a higher-urgency score. Additionally, the computer system can dynamically modify the scan route of the robotic system to preferentially locate, within the field of view of the robotic system, locations in the store associated with an urgency score exceeding the threshold urgency score and avoid locations in the store associated with an urgency score falling below the threshold urgency score.

In another example, the computer system can initiate the scan cycle at the robotic system. The robotic system can then, during a first time period within the scan cycle: autonomously navigate along the first scan route; and capture a first series of images of a first set of product units occupying a first set of inventory structures proximal the first scan route. The computer system can then—during the scan cycle—predict a list of product types omitted from imaging by the robotic system at a scheduled completion time of the scan cycle, while the robotic system is traversing the first scan route. The computer system can repeat this process for the other product types in the set of product types.

In a similar example, the computer system can calculate a second scan route for replacement of the first scan route—during the scan cycle—in response to the list of omitted product types including a particular product type assigned to a location associated with a first urgency score greater than a threshold urgency score. The computer system can repeat this process for the other product types in the set of product types.

Therefore, the computer system can recognize that—based on the robotic system's present progress in the scan cycle, or upon completion of a scan cycle—the robotic system will not successfully (or did not, in the case of scan completion) scan all high-urgency locations during the scan cycle. In response, the computer system automatically recalculates the route of the robotic system to prioritize unscanned locations in the store associated with higher urgency scores over unscanned locations in the store associated with lower urgency scores.

In another example, the computer system can: calculate the first scan route prior to a scheduled start time of the scan cycle and calculate the second scan route at the second time succeeding the scheduled start time of the scan cycle by a preset time interval. The computer system can then: at a third time succeeding the second time by the preset time interval during the scan cycle for a first product type in the set of product types: access a third elapsed time since a last scan of a location in the store assigned to the product type; calculate a third time remaining based on a third difference between the third elapsed time and a scan frequency assigned to the product type; and calculate a third urgency score of the location in the store based on the third time remaining. The computer system can then calculate a third scan route from a location of the robotic system at the third time, to the dock location in the store that—when traversed by the robotic system —preferentially locates within the field of view of the robotic system locations in the store associated with higher third urgency scores over locations in the store associated with lower third urgency scores. The computer system can repeat this process for the other product types in the set of product types.

Therefore, the computer system can recalculate the scan route of the present scan cycle based on recalculated urgency scores based on the real-time progress of the robotic system during the scan cycle, in contrast to a predefined set of urgency scores. Thus, the computer system can preferentially locate high-urgency, unscanned locations, over previously scanned, high-urgency locations. Therefore, the robotic system does not traverse to locations previously scanned, which would extend the time of the scan cycle. The computer system can recalculate the scan route at any point and any number of times during the scan cycle. In one situation in which the robotic system encounters a temporary obstruction (e.g., a human or shopping cart) along the scan route and is thus temporarily prevented from scanning a high-urgency location, the robotic system can: navigate around the obstruction; repeat Blocks of the method to recalculate a scan route responsive to the obstruction based on stored baseline scan frequencies for locations in the store and partial completion of the current scan cycle; autonomously navigate along the scan route to scan remaining high-urgency locations within the store, and selectively return to the obscured location within the store if prescribed by the new scan route.

In another variation—during the scan cycle—the robotic system can: navigate from a first location associated with a higher first urgency score to a second location associated with a higher second urgency score, along a route including waypoints proximal a third location associated with a lower third urgency score; and capture an image of a first set of product units occupying the third location. The computer system can then: store the image for processing at a third time, succeeding the second time; and, in response to a user request for the last image captured of the first set of product units, serve the image to the user. The computer system can repeat this process for the other product types in the set of product types.

Therefore, the robotic system and the computer system can cooperate to: preferentially navigate to and capture images of a first subset of locations assigned imaging schedules—according to their scan frequencies—that are soon to expire; and selectively avoid a second subset of locations assigned images schedules with more time until expiration (i.e., corresponding to failure to meet assigned scan frequencies).

Furthermore, the robotic system can opportunistically capture images of locations—in the second subset of locations—as the robotic system executes the scan route and navigates between the first subset of locations. The computer system can then access and process images of both the first and second subsets of locations to derive stock conditions of these locations in the store during this scan cycle. Alternatively, the computer system can: access and process images of the first subset of locations to derive stock conditions of these locations in the store during this scan cycle; store images of the second subset of locations; and selectively process these images of the second subset of locations if selectively or specifically queried by a user affiliated with the store.

### 17.1 Obstructions

Furthermore, during the scan cycle, an obstacle (e.g., a customer, a shopping cart, a spill, a temporary display) within an aisle may prevent the robotic system from continuing along the route, and the robotic system can pause the scan cycle while waiting for the obstacle to clear. However, durations of time remaining to scan outstanding slots before failing to fulfill assigned slot scan frequencies may continue to decrease even as the robotic system pauses for the obstacle to clear. The remote computer system and/or the robotic system can therefore: implement methods and techniques described above to regularly (e.g., once per second, once per minute) update the scores for these slots; temporarily update a map of the store to reflect the obstacle in this aisle; and recalculate a new route through the store. In particular, the computer system (or the robotic system) can calculate a new route that: when traversed by the robotic system, maximizes the sum of current scores of slots that fall within the scan field of the robotic system per consecutive unit distance along the route traversed by the robotic system; remains within the bounds of the store; and avoids collisions with known locations of both fixed inventory structures and the temporary obstacle. Then, if the new route differs from the last route, the robotic system can load and execute this revised route.

For example, the computer system can initiate the scan cycle at the robotic system. During a first time period within the scan cycle, the robotic system can: autonomously navigate along the first scan route; capture a first series of images of a first set of product units occupying a first set of inventory structures proximal the first scan route; and detect an obstruction along the first scan route. The computer system can then—in response to the robotic system detecting the obstruction along the first scan route—calculate a second scan route that traverses a path circumnavigating the obstruction, for replacement of the first scan route during the scan cycle. The computer system can repeat this process for any other obstruction encountered during a scan cycle.

Therefore, the computer system can automatically trigger the robotic system to immediately navigate around the obstruction via a second scan route.

In a similar example, the computer system can initiate the scan cycle at the robotic system. During a first time period within the scan cycle, the robotic system can: autonomously navigate along the first scan route; capture a first series of images of a first set of product units occupying a first set of inventory structures proximal the first scan route; detect an obstruction along the first scan route; pause for a pre-defined time interval; and—at the expiration of the time interval—calculate a second scan route. The computer system can repeat this process for any other obstruction encountered during a scan cycle.

Therefore, upon encountering an obstruction, the robotic system can pause for a predefined time interval (e.g., 30 seconds, 60 seconds) before the computer system calculates a second scan route to navigate to avoid the obstruction. If the obstruction clears during the predefined time interval, such as in the case of a temporary obstruction (e.g., a person or a shopping cart), then the robotic system can continue along the scan route unimpeded. Otherwise, the computer system can recalculate the scan route, transmit the new route to the robotic system, and the robotic system can navigate to avoid the obstruction.

### 18. Manual Scan Requests

In one variation, a user (e.g., a store manager, a store associate) may input a request to prioritize scanning within a particular area within the store—such as a particular slot, shelving segment, shelving structure, aisle, or section of the store—and the computer system (or the robotic system) can update scores for slots throughout the store accordingly, such as in real-time during a scan cycle.

For example, if the user selects a particular slot, shelving segment, shelving structure, aisle, or section of the store for prioritized scanning—such as via a map of the store rendered on a mobile device or by sending a textual request to the computer system via a SMS or MMS text message—the computer system can: identify slots located within the user's selection; and increase the scores assigned to these slots, such as by multiplying these current scores by a predefined priority factor (e.g., 1.8×), by adding a predefined priority factor (e.g., 40/100) to these current scores (up to a maximum score), or resetting these current scores to a maximum or highest-priority score (e.g., 95+/100). Then, if the robotic system is currently executing a scan cycle, the computer system (or the robotic system) can recalculate a route for the robotic system based on these updated scores, and the robotic system can transition to executing this new route accordingly. If the robotic system is not currently executing a scan cycle, the computer system (or the robotic system) can calculate a route for the robotic system based on these updated scores, and the robotic system can automatically begin executing this new route responsive to the user's request to scan or prioritize a particular area within the store. Alternatively, if the robotic system is not currently executing a scan cycle, the computer system (or the robotic system) can calculate a sum of the updated scores of slots throughout the store and trigger the robotic system to initiate a new scan cycle if this sum of scores exceeds a threshold score, such as described above.

In one variation, the computer system can: during a current scan cycle, predict a list of locations that will be omitted from imaging by the robotic system at the scheduled completion time of the current scan cycle, while the robotic system is traversing the first scan route and the second scan route during the current scan cycle. In response to the list of locations omitted from imaging by the robotic system including a first location assigned to a first product type associated with a first urgency score greater than a threshold urgency score, the computer system can: transmit a notification identifying the first location to a user affiliated with the store; and transmit a prompt to the user to confirm an unscheduled scan cycle—succeeding the current scan cycle—to image a subset of locations in the store, the subset of locations including the first location. In response to the user confirming the unscheduled scan cycle, the computer system can: queue the robotic system to execute the unscheduled scan cycle following completion of the current scan cycle. The computer system can then, for the first product type assigned to a first location in the subset of locations in the store: access a third elapsed time since a last scan of the location in the store; calculate a third time remaining based on a third difference between the third elapsed time and a scan frequency assigned to the product type; and calculate a third urgency score of the location in the store based on the third time remaining. The computer system can then calculate a third scan route that, when traversed by the robotic system, preferentially locates—within the field of view of the robotic system—locations in the store associated with higher third urgency scores over locations in the store associated with lower third urgency scores. The computer system can then load the third scan route at the robotic system for execution during the unscheduled scan cycle. The computer system can repeat this process for the other product types in the set of product types, or for any other scan cycle.

Therefore, the computer system can detect and identify that—based on the robotic system's present progress in the scan cycle, or upon completion of a scan cycle—the robotic system will not successfully (or did not, in the case of scan completion) scan all high-urgency locations during the scan cycle. In response, the computer system presents a user affiliated with the store with a recommendation for an additional, subsequent scan, in which the robotic system can complete a scan of the previously unscanned locations and prompts the user to confirm.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for deploying a robotic system to scan inventory within a store comprising:
for each product type in a set of product types stocked in the store:
retrieving a scan frequency assigned to the product type; and
accessing a set of locations in the store assigned to the product type;
at a first time, for a scan cycle executed by the robotic system deployed in the store:
for each product type in the set of product types:
accessing a first elapsed time since a last scan of a location in the store assigned to the product type;
calculating a first time remaining based on a first difference between the first elapsed time and a scan frequency assigned to the product type; and
calculating a first urgency score of the location in the store based on the first time remaining; and
calculating a first scan route traversable by the robotic system to preferentially locate, within the field of view of the robotic system, locations in the store associated with higher first urgency scores over locations in the store associated with lower first urgency scores;
at the robotic system, loading the first scan route for execution during the scan cycle;
at a second time during execution of the scan cycle by the robotic system:
for each product type in the set of product types:
accessing a second elapsed time since a last scan of a location in the store assigned to the product type;
calculating a second time remaining based on a second difference between the second elapsed time and a scan frequency assigned to the product type; and
calculating a second urgency score of the location in the store based on the second time remaining; and
calculating a second scan route, from a current location of the robotic system at the second time to a dock location in the store, traversable by the robotic system to preferentially locate, within the field of view of the robotic system, locations in the store associated with higher second urgency scores over locations in the store associated with lower second urgency scores; and
at the robotic system, loading the second scan route, in replacement of the first scan route, for execution during the scan cycle.

2. The method of claim 1:
wherein calculating the first scan route traversable by the robotic system comprises:
identifying a first set of locations in the store associated with a first set of first urgency scores, each urgency score in the first set of first urgency scores greater than a threshold urgency score;
identifying a second set of locations in the store associated with a second set of first urgency scores, each urgency score in the second set of first urgency scores less than the threshold urgency score;
generating the first scan route traversable by the robotic system:
to locate, within the field of view of the robotic system, the first set of locations in the store associated with the first set of first urgency scores; and
to minimize a traversal length between the first set of locations in the store; and
transmitting the first scan route to the robotic system; and
further comprising, at the robotic system during the scan cycle:
navigating along the first scan route to sequentially capture a first series of images of the first set of locations in the store; and
opportunistically capturing a second series of images of the second set of locations in the store, associated with the second set of first urgency scores, while navigating between the first set of locations along the first scan route.

3. The method of claim 1:
wherein calculating the first scan route traversable by the robotic system comprises:
identifying a first set of locations in the store associated with a first set of first urgency scores, each urgency score in the first set of first urgency scores greater than a threshold urgency score;
identifying a second set of locations in the store associated with a second set of first urgency scores, each urgency score in the second set of first urgency scores less than the threshold urgency score;
for each location in the first set of locations, defining a waypoint to locate the location within the field of view of an optical sensor arranged on the robotic system;
generating the first scan route that minimizes a traversal length between a set of waypoints defined for the first set of locations; and
transmitting the first scan route to the robotic system; and
further comprising, at the robotic system during the scan cycle:
navigating along the first scan route to sequentially capture an image of each location, in the first set of locations in the store, while occupying a corresponding waypoint in the set of waypoints; and
opportunistically capturing a series of images of the second set of locations in the store, associated with the second set of first urgency scores, while navigating between the set of waypoints along the first scan route.

4. The method of claim 1:
wherein retrieving a scan frequency assigned to the product type, for each product type in the set of product types, comprises:
accessing a database of recommended baseline scan frequencies, published by a corporate entity affiliated with the store, for a corpus of products stocked in a population of stores comprising the store; and
for each product type in the set of product types stocked in the store, loading a recommended baseline scan frequency from the database; and
further comprising:
presenting recommended baseline scan frequencies of product types of the set of product types to a user affiliated with the store;
prompting the user to adjust recommended baseline scan frequencies of product types of the set of product types; and
in response to receiving a first adjusted scan frequency, for the first product type, from the user, overwriting a first recommended baseline scan frequency, assigned to the first product type in the database, with the first adjusted scan frequency specific to the store.

5. The method of claim 1, wherein retrieving a scan frequency assigned to a product type, for each product type in the set of product types, comprises:
for each product type in a first subset of product types in the set of product types:
accessing a database of recommended baseline scan frequencies published by a manufacturer affiliated with the product type; and
loading a recommended baseline scan frequency for the product type from the database; and
for each product type in a second subset of product types in the set of product types:
identifying a supplier for the product type;
accessing a restocking fulfillment schedule for the supplier to the store;
extracting a time interval between scheduled restocking periods by the supplier to the store from the restocking fulfillment schedule; and
calculating a baseline scan frequency for the product type based on the time interval.

6. The method of claim 1, wherein retrieving a scan frequency assigned to a product type, for each product type in the set of product types, comprises:
accessing a predefined set of baseline scan frequency rules based on product category and sale rate for the store;
for a first product type, in the set of product types, comprising a frozen packaged good:
retrieving a first baseline scan frequency of approximately twice per day for frozen packaged goods from the set of baseline scan frequency rules; and
assigning the first baseline scan frequency to the first product type;
for a second product type, in the set of product types, comprising a fresh produce product:
retrieving a second baseline scan frequency of approximately once per day for fresh produce product from the set of baseline scan frequency rules; and
assigning the second baseline scan frequency to the second product type;
for a third product type, in the set of product types, comprising a first canned good characterized by sale rate greater than a threshold rate:
retrieving a third baseline scan frequency of approximately once per two-day interval for a canned goods at a first sale rate from the set of baseline scan frequency rules; and
assigning the third baseline scan frequency to the third product type; and
for a fourth product type, in the set of product types, comprising a second canned good characterized by sale rate less than a threshold rate:
retrieving a fourth baseline scan frequency of approximately once week for canned goods at a second sale rate, less than the first sale rate, from the set of baseline scan frequency rules; and
assigning the fourth baseline scan frequency to the fourth product type.

7. The method of claim 1, further comprising:
accessing a set of scan types;
for a first product type, in the set of product types, comprising a frozen packaged good:
retrieving a first scan type prescribing a temperature check from the set of scan types; and
assigning the first scan type to the first product type;
for a second product type, in the set of product types, comprising a fresh produce product:
retrieving a second scan type prescribing a quality check from the set of scan types; and
assigning the second scan type to the second product type; and
for a third product type, in the set of product types, comprising a high sell-through rate good characterized by a sell-through rate greater than a threshold rate:
retrieving a third scan type prescribing a stock check from the set of scan types; and
assigning the third scan type to the third product type.

8. The method of claim 1, wherein retrieving a scan frequency assigned to a product type, for each product type in the set of product types, comprises for a first product type in the set of product types:
accessing a first sale rate of the first product type, within a time interval prior to the scan cycle, from a point-of-sale system affiliated with the store;
retrieving a first quantity of product facings of the first product type assigned to a set of slots within the store; and
calculating a first scan frequency for the first product type proportional to the first sale rate of the first product type and inversely proportional to the first quantity of product facings of the first product type within the store.

9. The method of claim 1, further comprising:
at the robotic system:
initiating the scan cycle;
during a first time period within the scan cycle:
autonomously navigating along the first scan route; and
capturing a first series of images of a first set of product units occupying a first set of inventory structures proximal the first scan route; and
during a second time period within the scan cycle following the second time:
autonomously navigating along the second scan route; and
capturing a second series of images of a second set of product units occupying a second set of inventory structures proximal the second scan route;
deriving a first set of stock conditions in the first set of inventory structures within the store, during the scan cycle, based on features detected in the first series of images;
deriving a second set of stock conditions in the second set of inventory structures within the store, during the scan cycle, based on features detected in the second series of images;
retrieving a third set of stock conditions of a third set of product units occupying a third set of inventory structures within the store derived from features detected in a third series of images captured by the robotic system during a set of preceding scan cycles within the store; and
compiling the first set of stock conditions, the second set of stock conditions, and the third set of stock conditions into global inventory representation of the store.

10. The method of claim 7, further comprising:
accessing an inventory map of the store;
for each slot in a set of slots in the inventory map corresponding to a product unit in the first set of product units, for each slot in a set of slots in the inventory map corresponding to a product unit in the second set of product units, and for each slot in a set of slots in the inventory map corresponding to a product unit in the third set of product units:
annotating a slot of the inventory map with the time of the last inventory check of the slot, and a stock condition of the slot, at the time of the last inventory check; and
compiling the stock conditions corresponding to each slot in the annotated inventory map into a global stock condition of the store;
presenting the annotated inventory map and the global stock condition to a user; and
prompting the user to confirm the accuracy of the annotated inventory map and the global stock condition of the store.

11. The method of claim 1:
further comprising:
at the robotic system:
initiating the scan cycle; and
during a first time period within the scan cycle:
autonomously navigating along the first scan route; and
capturing a first series of images of a first set of product units occupying a first set of inventory structures proximal the first scan route; and
during the scan cycle, predicting a list of product types omitted from imaging by the robotic system, traversing the first scan route during the scan cycle, at a scheduled completion time of the scan cycle; and
wherein calculating the second scan route comprises, in response to the list of omitted product types comprising a particular product type assigned to a location associated with a first urgency score greater than a threshold urgency score, calculating the second scan route, for replacement of the first scan route during the scan cycle.

12. The method of claim 1:
further comprising, at the robotic system:
initiating the scan cycle; and
during a first time period within the scan cycle:
autonomously navigating along the first scan route;
capturing a first series of images of a first set of product units occupying a first set of inventory structures proximal the first scan route; and
detecting an obstruction along the first scan route; and
wherein calculating the second scan route comprises, in response to the robotic system detecting the obstruction along the first scan route, calculating the second scan route, for replacement of the first scan route during the scan cycle and avoiding the obstruction.

13. The method of claim 1, further comprising, during the scan cycle:
at the robotic system:
traversing from a first location associated with a higher first urgency score, to a second location associated with a higher second urgency score, along a route comprising waypoints proximal a third location associated with a lower third urgency score; and
capturing an image of a first set of product units occupying the third location;
storing the image for processing at a third time, succeeding the second time; and
in response to a user request for the last image captured of the first set of product units, serving the image to the user.

14. The method of claim 1, wherein retrieving a scan frequency assigned to each product type in the set of product types comprises, for each product in the set of product types:
identifying a first location in the store assigned to the product type;
accessing a first stock condition of the first location derived from a first set of images captured by the robotic system during a first scan cycle preceding the scan cycle;
accessing a second stock condition of the first location derived from a second set of images captured by the robotic system during a second scan cycle following the first scan cycle and preceding the scan cycle;
calculating a first rate of change of the first location based on the first stock condition and the second stock condition; and
setting a first scan frequency for the product type at the first location based on the rate of change.

15. A method for deploying a robotic system to scan inventory within a store comprising:
at a first time:
for each product type in a set of product types stocked in the store:
retrieving a scan frequency assigned to the product type;
accessing a first elapsed time since a last image of a slot in the store, assigned to the product type, was captured by the robotic system; and
calculating an urgency score for imaging the slot proportional to a difference between the first elapsed time and the scan frequency; and
calculating a first scan route traversable by the robotic system to preferentially locate, within the field of view of the robotic system, locations in the store associated with higher first urgency scores over locations in the store associated with lower first urgency scores;
at the robotic system:
autonomously navigating within the store according to the first scan route; and
capturing images of a first subset of slots in the store;
at a second time during execution of the scan cycle executed by the robotic system:
for each product type in a set of product types stocked in the store:
retrieving a scan frequency assigned to the product type;
accessing a second elapsed time since a last image of a slot in the store, assigned to the product type, was captured by the robotic system; and
recalculating an urgency score for imaging the slot proportional to a difference between the second elapsed time and the scan frequency; and
calculating a second scan route, from a current location of the robotic system to a dock location in the store, traversable by the robotic system to preferentially locate, within the field of view of the robotic system, locations in the store associated with higher first urgency scores over locations in the store associated with lower first urgency scores; and
at the robotic system:
loading the second scan route, in replacement of the first scan route;
autonomously navigating within the store according to the second scan route; and
capturing images of a first subset of slots in the store.

16. The method of claim 15:
further comprising, at the robotic system:
initiating the scan cycle; and
during a first time period within the scan cycle:
autonomously navigating along the first scan route;
capturing a first series of images of a first set of product units occupying a first set of inventory structures proximal the first scan route;
detect an obstruction along the first scan route;
pausing for a pre-determined time interval; and
at the expiration of the time interval, calculating a second scan route; and
wherein calculating the second scan route comprises, in response to the robotic system detecting the obstruction along the first scan route, calculating the second scan route for replacement of the first scan route during the scan cycle and avoiding the obstruction.

17. The method of claim 15, further comprising:
during the scan cycle, predicting a list of locations omitted from imaging by the robotic system, traversing the first scan route and the second scan route during the scan cycle, at a scheduled completion time of the scan cycle;
in response to the list of locations omitted from imaging by the robotic system comprising a first location assigned to a first product type associated with a first urgency score greater than a threshold urgency score:
transmitting a notification identifying the first location to a user affiliated with the store; and
transmitting a prompt to the user to confirm an unscheduled scan cycle succeeding the scan cycle to image a subset of locations in the store, the subset of locations comprising the first location; and
in response to the user confirming the unscheduled scan cycle:
queueing the robotic system to execute the unscheduled scan cycle following completion of the scan cycle;
for each product type assigned to a location in the subset of locations in the store:
accessing a third elapsed time since a last scan of the location in the store;
calculating a third time remaining based on a third difference between the third elapsed time and a scan frequency assigned to the product type; and
calculating a third urgency score of the location in the store based on the third time remaining;
calculating a third scan route traversable by the robotic system to preferentially locate, within the field of view of the robotic system, locations in the store associated with higher third urgency scores over locations in the store associated with lower third urgency scores; and
at the robotic system, loading the third scan route for execution during the unscheduled scan cycle.

18. A method for deploying a robotic system to scan inventory within a store comprising:
for each product type in a set of product types stocked in the store:
retrieving a generic recommended baseline scan frequency assigned to the product type; and
accessing a set of locations in the store assigned to the product type;
annotating a map of the store according to generic recommended baseline scan frequencies and locations of the set of product types;
presenting the map to a user affiliated with the store;
overwriting a first baseline scan frequency of a first product type, assigned to a first location in the store, based on a first input from the user;
at a first time, for a scan cycle executed by the robotic system deployed in the store:
for each product type in a set of product types stocked in the store:
retrieving a scan frequency assigned to the product type;
accessing a first elapsed time since a last image of a slot in the store, assigned to the product type, was captured by the robotic system; and
calculating an urgency score for imaging the slot proportional to a difference between the first elapsed time and the scan frequency; and
calculating a first scan route traversable by the robotic system to preferentially locate, within the field of view of the robotic system, locations in the store associated with higher first urgency scores over locations in the store associated with lower first urgency scores; and
at the robotic system:
autonomously navigating within the store according to the first scan route; and
capturing images of a first subset of slots in the store.

19. The method of claim 18, further comprising:
at a second time during execution of the scan cycle by the robotic system:
for each product type in the set of product types:
accessing a second elapsed time since a last scan of a location in the store assigned to the product type;
calculating a second time remaining based on a second difference between the second elapsed time and a scan frequency assigned to the product type; and
calculating a second urgency score of the location in the store based on the second time remaining; and
calculating a second scan route, from a current location of the robotic system at the second time to a dock location in the store, traversable by the robotic system to preferentially locate, within the field of view of the robotic system, locations in the store associated with higher second urgency scores over locations in the store associated with lower second urgency scores; and
the robotic system, loading the second scan route, in replacement of the first scan route, for execution during the scan cycle.

20. The method of claim 18, wherein overwriting the first baseline scan frequency of the first product type comprises:
receiving the first input, from the user, linking the first baseline scan frequency of the first product type to a sell-through rate of the first product type;
calculating a revised scan frequency of the first product type inversely proportional to the sell-through rate of the first product type published by a point-of-sale system in the store; and
overwriting the first baseline scan frequency of the first product type, in the map, according to the revised scan frequency.
